(19) United States
(12) Patent Application Publication
(10) Pub. No.: US 2021/0046824 A1
(43) Pub. Date: Feb. 18, 2021

(54) Energy-Recapturing Propeller System for Vehicles

(71) Applicants: Aanya Sahu, Wood Dale, IL (US); Florian Halimi, Long Grove, IL (US)

(72) Inventors: Aanya Sahu, Wood Dale, IL (US); Florian Halimi, Long Grove, IL (US)

(21) Appl. No.: 16/993,063

(22) Filed: Aug. 13, 2020

Related U.S. Application Data
(60) Provisional application No. 62/887,709, filed on Aug. 16, 2019.

(51) Int. Cl. B60L 8/00; B60L 50/60; B60L 53/52; F03D 9/32; F03D 9/25

(52) U.S. Cl. CPC B60L 8/006; B60L 50/60; B60L 53/52; B60L 1/00; F03D 9/25; B60L 2220/20; F03D 9/32

(57) ABSTRACT

The present invention provides a system for charging an electric storage battery by generating electricity. According to the present invention the system comprises: a base frame; an energy-generation structure mounted at the base frame, the energy-generation structure having: a propeller rotatably mounted to an axle, the axle permits the propeller to spin freely when an input wind energy impinges on the propeller, and a direct current (DC) generator motor connected to the axle, such that the DC generator motor generates electricity when the axle is spun; wherein the energy generation structure is connected to a battery and is configured to provide electricity generated by the DC motor to the battery. The system extends the driving range of the vehicle.

### CROSS-REFERENCE OR RELATED PATENT APPLICATIONS

Provisional Patent Application No. 62/887709

### STATEMENT REGARDING FEDERALLY APPROVED RESEARCH OR DEVELOPMENT

None

### BACKGROUND OF THE INVENTION

### Field of the Invention

This invention relates generally to a system for generating electricity for a vehicle, and more particularly to a system for harnessing wind energy to charge an electric battery of a vehicle.

### Background Art

With the advent of the automotive technology, fossil fuel powered internal combustion engines were developed to power the vehicles. However, the fossil fuel powered engines were found to be one of the main contributors of the environment pollution. In order to reduce the emissions, hybrid vehicles and electric vehicles (EV) were developed to power the vehicles which utilize a renewable source of energy which is considered as environmental friendly.

Hybrid motor vehicles are powered by an internal combustion engine in association with the electric motors being powered by the battery. Whereas all electric vehicle are those vehicles which are powered exclusively by an electric driven motor.

In the vehicle industry, electric vehicles and hybrid gas/electric vehicles are becoming more prevalent. While these vehicles may be appealing to consumers, they suffer from a limited driving range due to limited battery capacity, especially for all electric vehicles. Moreover, the driving range depends upon the single charge of the electric battery.

In comparison with the conventional fossil fuel refueling stations, the electric charging stations are very less. Further, the time required to recharge the batteries is significantly longer than the time required to fill the fuel tank of a vehicle that runs on gasoline or diesel fuel.

It has been observed that while charging stations exist to allow electric vehicles to recharge, they may not exist in all areas where drivers need them, and may prevent drivers from leaving a particular location while waiting for the vehicle's battery to charge.

It has also been observed that these charging stations draw their energy from a source that is not considered “green,” for example sources as fossil fuels and other non-renewable sources of energy, which may have a negative effect on the environment and thus reverses the effect of adapting green technology.

Some estimates show that 28% of greenhouse gas emissions result from fossil fuels used to generate electricity. Other estimates show that 29% of all greenhouse gas emission comes from the transportation industry. Thus, it is believed that reducing greenhouse gas emissions in these areas can help improve air quality and the broader global environment.

With the developments in technology, wind energy was found to be an additional energy resource which can be harnessed to recharge the battery of the all electric vehicle to extend its driving range which generally requires mounting the wind turbine device on the vehicle for converting the wind energy into electrical energy. It has been observed that these devices capturing the energy have the limitations as the wind energy is recaptured only at running condition of the vehicle and these devices do not have any provisions of recharging the battery while the vehicle is stationary.

Moreover, current vehicles, including cars, trucks, boats, bicycles, and the like, generally lack devices for recapturing used energy (e.g., artificial wind energy created as a result of the vehicle's movement) or for capturing natural wind energy while stationary or in motion.

It has also been observed that an auxiliary wind turbines are used along with the main roof mounted wind turbines wherein the main turbine functions while running the vehicle and the auxiliary turbine functions while the vehicle is at stationary position. This increases the complexities in using the device.

Further, due to their existing design and configuration these devices make them bulky and costly.

Therefore, the object of the present invention is to solve one or more of the aforesaid issue. It would be desirable to harness wind energy while the vehicle is being driven, as well as to charge the battery by harnessing wind energy while the vehicle is parked.

### SUMMARY OF THE INVENTION

The present invention provides a system for charging an electric storage battery by generating electricity. According to the present invention the system comprises: a base frame; an energy-generation structure mounted at the base frame, the energy-generation structure having: a propeller rotatably mounted to an axle, the axle permits the propeller to spin freely when an input wind energy impinges on the propeller, and a direct current (DC) generator motor connected to the axle, such that the DC generator motor generates electricity when the axle is spun; wherein the energy generation structure is connected to a battery and is configured to provide electricity generated by the DC motor to the battery. The system extends the driving range (i) while the vehicle is in running condition, and (ii) while the vehicle is parked or at stationary position.

According to the present invention, the energy generation structure is rotatably mounted around the base frame. The propeller of the energy generation structure comprises a plurality of blades to receive input wind energy. Further, the energy generation structure includes a trailing vane attached at the opposite side of the propeller to orient the propeller in accordance with the flow direction of the input wind energy.

According to the present invention, the base frame is fixed at the front section of the roof of the vehicle. The base frame comprises an upper cylindrical part fixedly connected with the energy generation structure and a lower cylindrical part fixedly connected with the base of the frame. The base frame further comprises a rotating means adapted between the upper part and lower part of the base frame to permit orientation of the propeller system when vehicle is at stationary position.

According to the present invention, the base frame comprises a locking means adapted between the upper part and lower part to lock the orientation of the propeller when vehicle is at running condition.

The energy-generation structure comprises a housing for enclosing a charging port for charging the auxiliary devices whereas the charging port is electrically connected to the power outlet of the DC motor. The present system further comprises a controller connected with the power terminal of the DC generator motor at one end and to a battery at another end. The controller controls the amount of DC current recharging a battery.

The housing, propeller of energy generation structure and base frame is made up of a material consisting but not limited to Polyvinyl chloride (PVC), plastic, metal etc.

Further, the system also includes sensors for measuring the wind speed. The sensors adapted at the energy generation structure are connected with the controller whereas the controller is configured to control tip speed ratio of the blades within in a predetermined range in order to draw a maximum amount of energy from the wind.

Generating or recapturing energy through the present system may also help reduce other harmful effects caused by air pollution. For example, air pollution has been linked to depletion of the ozone layer, acid rain, harming the health of crops (including killing crops), and harmful effects to organisms, in addition to being linked to detrimental effects on climate change.

The present system recaptures the vehicle's energy as the vehicle is in motion, such as by using the propellers motion to recharge a portion of the vehicle's batteries and thereby extending its range. It may also capture natural wind energy while the vehicle is in a stationary state (e.g., when parked outside in a windy environment), further charging the battery and extending the driving range of the vehicle.

The system provides a further benefit by charging a vehicle's batteries through a source of energy that is considered “green” because it is a renewable resource, whereas traditional charging stations for electric vehicles

### BRIEF DESCRIPTION OF THE DRAWINGS

Reference will be made to embodiments of the invention, example of which may be illustrated in the accompanying figure(s). These figure(s) are intended to be illustrative, not limiting. Although the invention is generally described in the context of these embodiments, it should be understood that it is not intended to limit the scope of the invention to these particular embodiments.

FIG. 1 shows a system in accordance with an embodiment of the present invention for charging the battery of the vehicle while the vehicle is in motion;

FIG. 2 shows a system in accordance with an embodiment of the present invention for charging the battery of the vehicle while the vehicle is parked or at stationary position;

FIG. 3 shows an isometric view of the configuration of the base frame of the system in accordance with an embodiment of the present invention;

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

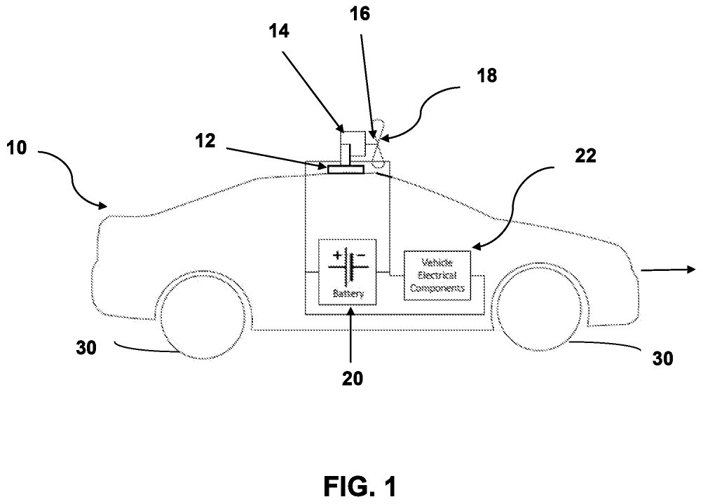

Referring to the FIG. 1, it shows a system for generating electricity for a vehicle 10 having wheels 30, the system comprising: a base frame 12; an electricity generation structure 14 rotatably mounted around the base frame 12. The base frame 12 is attached at the roof of the vehicle 10. The electricity generation structure 14 comprises a propeller 18. The propeller 18 is rotatably mounted to an axle 16 of the energy generation structure. The axle permits the propeller 18 to spin freely when the wind energy impinges on the blades of the propeller 18 while the vehicle 10 moves in forward direction. The electricity generation structure 14 comprises a DC generator motor (not shown) connected to the axle 16, such that the motor generates electricity when the axle 16 is spun. The vehicle is having a battery 20, wherein the battery 20 is electrically connected to the power outlet of the energy-generation structure 14 and is configured to receive electricity generated by the generator motor during running condition of the vehicle 10. When the wheel 30 of the vehicle 10 rotates and the vehicle 10 moves in forward direction, the flowing wind causes the blades of the propeller 18 to rotate and generate the DC current which recharges the battery 20 of the vehicle 10.

According to an embodiment of the present invention, the battery of the system is the main battery which powers the vehicle to run.

According to the present invention, the propeller of the system comprises a plurality of blades which rotate when the flowing input wind impinges.

In FIG. 1, the vehicle 10 includes a battery 20 which is electrically connected to both the propeller system and the electrical components 22 of the vehicle (e.g. headlights, taillights, turn indicators, horn, etc.). As shown, the battery 20 is located at the central portion of the vehicle 10; however it may be obvious to a skilled person to locate the battery 20 at other portions of the vehicle 10 including being provided in an elongated configuration below the floor boards of the vehicle 10.

According to another embodiment of the present invention, the electricity energy generated by the propeller system may charge the vehicle's battery 20 and/or directly power the electrical components 22 of the vehicle 10, including power outlets of the vehicle 10 or devices attached to those power outlets. Alternatively, power outlets (not shown) (e.g., 12 VDC charging ports) can be built directly into the housing of the energy generation structure as opposed to the conventional propeller system merely powering outlets or ports that are built inside the vehicle.

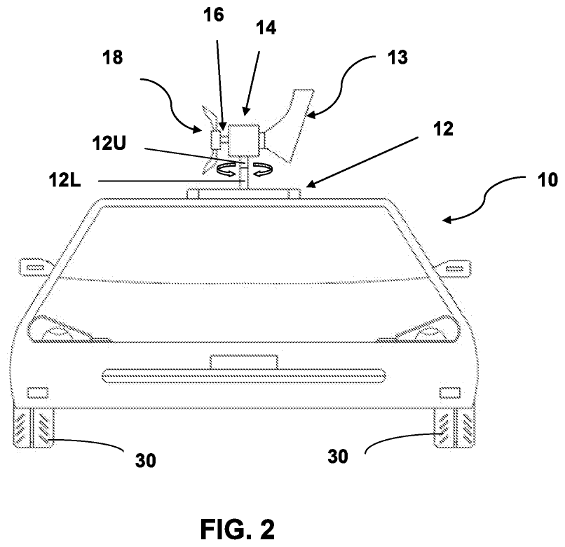

FIG. 2 shows a system for generating electricity for a stationary or parked vehicle in accordance with another embodiment of the present invention. The system comprises a base frame 12, an energy generation structure 14 rotatably mounted around the base frame 12. The electricity generation structure comprises a propeller 18 rotatably mounted to an axle 16. The axle 16 permits the propeller 18 to spin freely when the wind energy impinges on the propeller 18. The energy generation structure 14 further comprises a DC generator motor connected to the axle 16, such that the motor generates DC current when the axle 16 is spun. The system further comprises a battery electrically connected to the power outlet of the DC generator motor. The battery of the system is configured to receive electricity generated by the generator motor while the vehicle is at parked or stationary position. During parking or stationary position the propeller 18 receives the wind energy flowing therein or the wind energy caused by the nearby moving vehicle. According to the present invention, the base frame 12 of the energy-generation structure comprises an upper part 12U; a lower part 12L, a rotating means. The upper part 12U is fixedly connected with the energy generation structure 14. The lower part 12L is connected with the base frame 12. The base frame comprises the rotating means fixed between the upper part 12U and the lower part 12L of the base frame 12 which allow orientation of the energy generation structure 14 when the wind impinges on the propeller. The energy generation structure 14 includes a trailing vane 13 adapted at the opposite side of the propeller 18. The energy generation structure 14 is guided by the trailing vane 13 to rotate in the direction of the airflow using the dynamics of the design of the trailing vane 13. The trailing vane 13 receives the natural wind as well as the artificial wind generated from the moving or passing vehicle nearer to the vehicle 10. The trailing vane turns to evenly distribute the airflow on both sides of the trailing vane 13 thus rotating the device in the direction of the airflow over the vehicle 10. In stationary state (e.g., when parked outside in a windy environment), the system charges the battery and extends the driving range of the vehicle.

In accordance with the present invention, the axis of the rotation of the propeller 18 is orthogonal to the axis of rotation of the energy generation structure 14.

In accordance with an embodiment of the present invention, the system may comprise a controller connected with the power terminal of the DC generator motor at one end and to a battery at another end. The controller controls the amount of DC current recharging a battery. Further, the system may include a diode to prevent the reverse current flow from the battery to the DC generator motor.

In accordance with the present invention, the base frame is fixed at the roof of the vehicle at its front section. However, the base frame may be fixed at another location where the one of ordinary skill would know the maximum air flow may be received by the propeller considering the design and size of the vehicle. The propeller system may be affixed to many different locations of a vehicle, depending on the nature of the vehicle, the shape of the propeller system, the weight of the propeller system, or the like. While FIGS. 1 and 2 show exemplary embodiments of a propeller system affixed to the roof of a vehicle, other arrangements are possible. For example, in some embodiments, the propeller system may be affixed behind the grille of an automobile, which may allow for easier integration into the vehicle and may also prevent adding extra drag to the vehicle.

In accordance with an embodiment of the present invention, the base frame is detachably mounted on the upper section of the vehicle. The user driver may detach the energy generation structure device when there is no requirement. The base frame comprises mechanical means at its bottom section for securing the base frame to the vehicle.

In accordance with other embodiments of the present invention, the energy generation structure of the present invention can be fixedly mounted at the top section of the vehicle by piercing the through holes on the top section of the hole and fastening the base frame via. nuts and bolts.

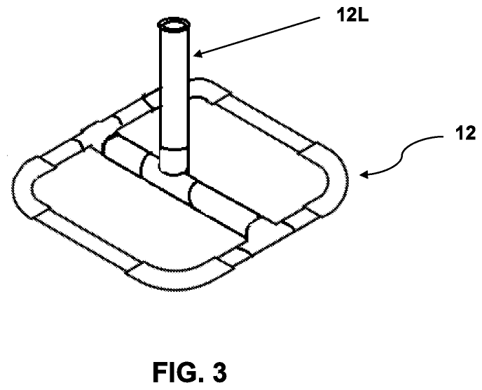

FIG. 3 shows an isometric view of the configuration of the base frame in accordance with a non-limiting embodiment of the present invention. The base frame can be manufactured by adjoining the parts made up of PVC. The base frame comprises a hollow cylindrical mounting tube fixed at the center of the frame 12 to mount the energy generation structure. The hollow cylinder includes an upper part (not shown) and a lower part 12L. The upper part is rotatably connected with the lower part via bearing adapted inside the cylindrical tube. The upper part of the cylinder is connected with the energy generation structure whereas the lower part 12L of the hollow cylinder is connected with the base of the frame 12. According to the present invention, the tube may be made-up of a material including but not limited to plastic, Poly Vinyl Chloride (PVC), metal etc.

In accordance with the present invention, the base frame comprises a locking means to lock the upper part 12U and the lower part 12L of the base frame 12 when the vehicle starts moving from the stationary position or parked position to the running condition. As the direction of the propeller is required to be straight while running the vehicle, the orientation of the energy generation structure is locked via. locking means.

In accordance with an embodiment of the present invention, the locking means can be a clamp or similar means connected to both the interior and the exterior of the upper and lower part of the hollow cylindrical tube. The ordinary person skilled in the art would appreciate that the clamp can be tightened to lock the upper and lower part of the cylindrical tube in order to lock the orientation of the system while the vehicle is in running condition. Alternatively, the upper part and lower part may comprise other locking mechanisms which can secure the locking of the two hollow cylindrical parts.

In accordance with the present invention, the device can be unlocked by operating locking means while leaving the vehicle in stationary or parked position. Upon unlocking, the rotating means adapted between the upper and lower part of the base frame functions as to rotate the energy generation structure over the base frame freely in accordance with the flow direction of the wind.

In accordance with the present invention, the present application has a technical advantage over the conventional devices that a single energy recapturing system can be used to recapture the wind energy and generate electricity in both the conditions (i) while the vehicle is in running condition whereas the locking means locks the orientation of the propeller; and (ii) while the vehicle is at stationary or parked position whereas the rotating means allows the free movement of the propeller guided by the trailing wane in accordance with the flow direction of flowing wind over the blades of the propeller.

In some embodiments of the present invention, the propeller system includes blades attached to an axle and the base frame. The base frame may be affixed to a vehicle (e.g., an automobile, a boat, a bicycle, etc.) and allow the axle and blade to spin freely. The propeller system may include a single blade or plurality of blades. These blades may have any number of shapes, which are known to those of ordinary skill in the art. In some embodiments, the propeller system may be made from plastics, metals, and other materials suitable for propellers that are known to those of ordinary skill in the art.

The propeller system may generate power by virtue of spinning a structure that includes a motor and/or any number of magnets and solenoids, combinations and structures of which are known to those of skill in the art. In other embodiments, the propeller system may not include a blade, motor, solenoid, or magnet, but may rather generate power through a piezoelectric device. For example, pressure on the piezoelectric device from the wind may generate electricity. A piezoelectric device may affix to different areas of the vehicle, just as a propeller-based system.

The person skilled in the art would appreciate that the size of the wind turbine blades may be increased to increase the energy captured by the wind turbine. However, it may be apparent to those having the ordinary skilled that as blades have increased in size; it becomes increasingly more difficult to control optimum energy capture whereas the blade loading is dependent upon the wind speed, pitch angle of the blade and tip speed ratio (TSR) of the blade.

The tip speed ratio can be understood as follows:

$$Tip Speed Ratio ( TSR ) = \frac{Tip Speed of Blade}{Wind Speed}$$

In accordance with an embodiment of the present invention, the system of the present invention comprises blades having an adjustable pitch angle. The system further comprises sensors adapted on the energy generation structure for measuring wind speed and parameters of the energy generation structure. The sensors and the blades with adjustable pitch angle are connected with the controller of the system whereas the controller of the system is configured to calculate the wind speed and associated parameters of the energy generation structure and to control the speed of the rotating blades. The pitch settings of the blade may be varied or adjusted to control the wind turbine. The Controller of the wind turbine is configured to adjust/vary the speed of blade rotor by adjusting/varying the blade pitch in a manner that results into increment or decrement of energy transfer from the wind. The controller is also configured to control the tip speed ratio (TSR) of blades in a predetermined optimum range in order to draw the maximum amount of power from the wind.

Given the relatively small size of the propeller system, it allows for significant scalability, such that the reclaimed or generated energy can be used for a variety of purposes. In some situations, a single small propeller system may be sufficient for powering components or devices within a vehicle that do not consume large amounts of power. For example, a single small propeller system, such as the system shown in FIG. 1, may be used to power a portable music player or telephone. In some embodiments, however, affixing multiple smaller propeller systems and/or a larger propeller system to a vehicle could reclaim or generate even more power. This power could be used for a broader range of purposes, such as to charge the car's propulsion battery to extend the driving range of the vehicle.

Thus, it should be evident that a system for harnessing wind energy to charge an electric storage battery of an all-electric motor vehicle in accordance with inventive concepts of the present invention which has been shown and described in sufficient detail to enable one of ordinary skill in the art to practice the invention. Although not illustrated and described above, it will be under stood that practicing the invention requires routing electrical cables from electrical output terminals of the DC generator motor of the energy generation structure through the vehicle to its battery.

Since various modifications in detail, materials, arrangements of parts, and equivalents thereof, are within the spirit of the invention herein disclosed and described, the scope of the invention should be limited solely by the scope of the appended patent claims.

1. A system for generating electricity for a vehicle, the system comprising:
a base frame;
an energy-generation structure mounted at the base frame, the energy-generation structure having: a propeller rotatably mounted to an axle, the axle permits the propeller to spin freely when an input wind energy impinges on the propeller, and a direct current (DC) generator motor connected to the axle, such that the DC generator motor generates electricity when the axle is spun;
wherein the energy generation structure is connected to a battery and is configured to provide electricity generated by the DC motor to the battery.

2. The system as recited in claim 1, wherein the energy generation structure is rotatably mounted around the base frame.

3. The system as claimed in claim 1, wherein the axis of the rotation of the propeller is orthogonal to the axis of rotation of the energy generation structure.

4. The system as recited in claim 1, wherein the propeller comprises a plurality of blades to receive input wind energy.

5. The system as recited in claim 1, wherein the energy generation structure comprises a trailing vane attached at the opposite side of the propeller to orient the propeller in accordance with the flow direction of the input wind energy.

6. The system as recited in claim 1, wherein the base frame comprises an upper cylindrical part fixedly connected with the energy generation structure and a lower cylindrical part fixedly connected with the base of the frame.

7. The system as recited in claim 6, wherein the base frame comprises a rotating means adapted between the upper part and lower part of the base frame to permit orientation of the propeller system when vehicle is at stationary position.

8. The system as recited in claim 6, wherein the base frame comprises a locking means adapted between the upper part and lower part to lock the orientation of the propeller when vehicle is at running condition.

9. The system as recited in claim 1, wherein the base frame is mounted detachable or fixed at the upper section of the vehicle.

10. The system as recited in claim 1, wherein the housing, propeller of energy generation structure and base frame is made up of a material consisting but not limited to Polyvinyl chloride (PVC), plastic, metal etc.

11. The system as recited in claim 1, wherein the system comprises a controller connected with the power terminal of the DC generator motor at one end and to the battery at another end.

12. The system as recited in claim 11, wherein the system includes sensors for measuring the wind speed, the sensors are connected with controller.

13. The system as recited in claim 11, wherein the controller is configured to control tip speed ratio of the blades within in a predetermined range in order to draw a maximum amount of energy from the wind.

14. The system as recited in claim 1, wherein the energy-generation structure comprises a housing for enclosing a charging port.

15. The system as recited in claim 14, wherein the charging port is electrically connected to the power outlet of the DC motor.

16. The system as recited in claim 1, wherein the system extends the driving range of the vehicle.

17. A Vehicle comprising the system as recited in claim 1.
